(19) United States
(12) Patent Application Publication
(10) Pub. No.: US 2021/0347694 A1
(43) Pub. Date: Nov. 11, 2021

(54) FORMULATION COMPRISING A CELLULOSE ETHER AND/OR A POLYSACCARIDE, AND A FATTY ALCOHOL

(71) Applicant: SE TYLOSE GMBH & CO. KG, Wiesbaden (DE)

(72) Inventors: Vanessa HAVENITH, Wiesbaden (DE); Claus-Jochen HÄCKER, Wiesbaden (DE); Heiko NEBEL, Wiesbaden (DE)

(21) Appl. No.: 17/282,223

(22) PCT Filed: Oct. 2, 2019
(86) PCT No.: PCT/EP2019/076705

§ 371 Date: Apr. 1, 2021

(30) Foreign Application Priority Data
Oct. 4, 2018 (EP) 18198634.0

(51) Int. Cl. C04B 28/04; C04B 40/00

(52) U.S. Cl. CPC C04B 28/04; C04B 2111/00517; C04B 40/0042

(57) ABSTRACT

The invention relates to a preparation comprising at least one cellulose ether and/or at least one polysaccharide and at least one fatty alcohol, and to the production and use thereof, in particular in construction materials.

The invention relates to a preparation comprising at least one cellulose ether and/or at least one polysaccharide and at least one fatty alcohol, and to the production and use thereof, in particular in construction materials.

Cement-based adhesives, plasters, spackling pastes, and special adhesive and reinforcing fillers for thermal insulation composite systems are used to join or coat components in the construction industry. These are mixtures of one or more binders (e.g. cement, hydrated lime), fillers (e.g. sands with different grain sizes) and other additives such as cellulose ethers, dispersion powders, starch, starch derivatives such as starch ethers and air-entraining agents. These construction materials are called dry factory-produced mortar because they are produced in the factory and only need to be mixed with water for processing.

Cement-based tile adhesives are usually applied using the thin-bed technique, which requires a level surface on which the adhesive is applied in a layer of even thickness using a notched trowel. Tiles are laid across the entire surface of the adhesive mortar applied in this way, and aligned. The aim of the processors is an effective and efficient operation which involves applying the adhesive over a large surface so that the tiles can then be laid. For this purpose, the tile-laying time or open time or wetting time of the adhesive needs to be as long as possible in order to ensure that the back of the tile is wetted over the surface. The main components of thin-bed adhesives include cement, sand and rock flour, as well as cellulose ethers. To optimise the processing properties and solid mortar properties, further additives such as dispersion powders, starch derivatives, cement accelerators, inorganic thickeners and fibres can be included.

The open time of tile adhesives is determined in accordance with ISO 13007 or EN 1346. The tile adhesive is applied to a standardised concrete slab. Absorbent tiles are laid into the adhesive after a defined period of time, stored for several weeks under defined conditions and then pulled off using a pull-off tester. The resulting pull-off test values define the type of tile adhesive, whereby high-quality adhesives (C1 and C2) should achieve pull-off test values of ≥0.5 N/mm² after a laying time of 30 minutes. So-called wetting tests based on DIN EN 1347 can be carried out at the same time as this test. The same absorbent tiles used to determine the open time can be used for this purpose. These tiles are also laid in the mortar bed after defined periods of time, weighted down with 2 kg weights for 30 seconds and then removed, with the remaining mortar residue on the back of the tile being determined as a percentage. High quality tile adhesives should have a surface of >50% wetted with mortar on the back of the tile after 30 minutes.

A general problem with tile adhesives is early film formation or carbonation on the surface of the combed mortar, which shortens the wetting time and thus contributes to poorer adhesion of the tiles and a shorter open time. The same applies to plasters, adhesive and reinforcing fillers for thermal insulation composite systems and other cement-based dry mortars, in the case of which premature drying out impedes further work steps or impairs the material properties. The following patents describe the use of fatty alcohols in various applications in order to counteract the problems of premature drying out:

U.S. Pat. No. 3,486,916 describes the use of an emulsion of fatty alcohols (C₁₄₋₂₀) which delays the evaporation of water by means of an inhibiting film on the surface of objects cast from hydraulic cement mixtures.

The subject matter of EP 0 977 716 B1 is the use of fatty alcohols with 8 to 72 carbon atoms as an additive for plasters and mortars. The fatty alcohols, saturated or unsaturated, straight-chain or branched, are in the form of an aqueous alcohol dispersion and are applied to a solid (siliceous) carrier substance, the additive produced being in powder form and leading to favourable properties in the plaster or mortar, such as a longer processing time and an extended open time.

Other patents such as WO 2002/031069 A1 or EP 1322716 B1 mention the use of waxes or fatty alcohols as additives to extend the open time or the processing time in levelling and insulating compounds based on epoxy resin. The administration form is either powder, with the fatty alcohols (C₁₆₋₇₂) being applied to a carrier, or liquid in the form of an aqueous emulsion. The amount used is 0.1-2.0 wt. %, based on the total formulation.

WO 1995/004008A1 relates to the use of C₁₄₋₂₂ fatty alcohols in an amount of 0.05 to 3 wt. %, based on the cement content, which prevent lime bloom in a hydraulic cement mixture.

US 2003/0209170 A1 concerns minimising dust on the surface of cement and concrete structures through the use of C₁₂₋₂₂ fatty alcohols in combination with a shrinkage-reducing additive.

U.S. Pat. No. 5,807,502 describes the use of C10-28 fatty alcohols as defoamers in the construction industry.

U.S. Pat. No. 9,005,752 B2 likewise describes the use of C16-18 fatty alcohol derivatives as defoamers which are applied to a siliceous carrier substance together with a silicone oil. The defoaming effect is intended to improve the flexural and compressive strengths as well as the pull-off test values during freeze-thaw storage in dry mortars.

The use of fatty alcohols, traded as the Loxanol OT range by BASF Ludwigshafen, as open-time extenders in paints, dispersion-bound construction materials, plasters and mortars is also known. Liquid dispersions and fatty alcohols on siliceous carrier materials are commercially available.

The prior art describes the use of fatty alcohols or fatty alcohols in liquid form, since they are only soluble in water in powder form or in the solid state to a limited extent. The use of liquid fatty alcohols, for example in the form of emulsions or dispersions, is not user-friendly if they are to be used in dry mortar systems such as tile adhesives or adhesive and reinforcing fillers for thermal insulation composite systems. A two-component system should be provided here: One component is the aqueous fatty alcohol phase, which is also used as the mixing water. The second phase consists of the dry mortar mixture. User errors or dosing errors cannot be excluded here. Moreover, a correspondingly larger storage space is required commercially and on construction sites. Dry mixtures are therefore preferred.

Powdered fatty alcohol additives usually contain a carrier substance that can have adverse effects on the construction material system. In contrast to cellulose ethers, siliceous carrier substances such as those used in conventional powdered fatty alcohol additives, e.g. Loxanol OT 5900 from BASF Ludwigshafen, are immobile during the drying process and therefore not particularly effective in extending the wetting time or open time.

The problem addressed by the present invention is that of providing a solid additive for construction material systems which significantly extends the wetting time and/or the open time of the construction material systems and significantly improves the pull-off test values of the construction material systems. It should be possible to add the additive to the dry construction material system. The problem has been solved by a preparation comprising
(i) at least one cellulose ether and/or at least one polysaccharide or a derivative thereof, preferably at least one cellulose ether,
(ii) at least one fatty alcohol or a dimer or trimer thereof,
(iii) optionally at least one hydraulic binder and
(iv) optionally at least one aggregate.

It is known that powdered fatty alcohols are only soluble in water to a limited extent, which is why they are either in the form of an emulsion or dispersion or have to be applied to a carrier material in order to develop their effectiveness in mortar systems. As already mentioned, fatty alcohol emulsions are not user-friendly and the existing powdered fatty alcohols on carrier substances are not sufficiently effective with regard to the open time and wetting time. It has been shown that fatty alcohols can be converted into a powdered, stable and highly reactive form with cellulose ether.

The preparation according to the invention preferably contains less than 20 wt. %, preferably less than 15 wt. %, more preferably 0-10 wt. %, even more preferably 0.01-8 wt. % water, based on the total mass of the preparation.

Components (i) and (ii) are preferably present as solids in the preparation according to the invention. Component (i) and component (ii) particularly preferably form a particle together. Component (i) and component (ii) are preferably homogeneously distributed in the particle. Thus, the cellulose ether and/or the polysaccharide and the fatty alcohol in the preparation according to the invention can either be fused with one another or the fatty alcohol forms a film around the cellulose ether and/or the polysaccharide. In a particularly preferred embodiment, component (i) and component (ii) are present in the form of a solid solution. The average diameter d₅₀ of the particle is preferably in the range of 0.01-1,000 μm, preferably 0.01-500 μm, more preferably 0.01-250 μm.

The cellulose ether is preferably selected from methyl cellulose (MC), methyl hydroxypropyl cellulose (MHPC), methyl hydroxyethyl cellulose (MHEC), hydroxyethyl cellulose (HEC), ethyl hydroxyethyl cellulose (EHEC), methyl ethyl hydroxyethyl cellulose (MEHEC), carboxymethyl cellulose ether (CMC), carboxymethyl hydroxyethyl cellulose ether (CMHEC), carboxymethyl hydroxypropyl cellulose ether (CMHPC), carboxymethyl methyl cellulose ether (CMMC), carboxymethyl methyl hydroxyethyl cellulose ether (CMMHEC), carboxymethyl methyl hydroxypropyl cellulose ether (CMMHPC), sulfoethyl methyl cellulose ether (SEMC); sulfoethyl methyl hydroxyethyl cellulose ether (SEMHEC), sulfoethyl methyl hydroxypropyl cellulose ether (SEMHPC) and methyl hydroxyethyl hydroxypropyl cellulose ether (MHEHPC), more preferably methyl hydroxypropyl cellulose and methyl hydroxyethyl cellulose.

Particularly preferable are methyl cellulose which has an average degree of substitution DS_{methyl} of 1.4 to 2.2, preferably 1.6 to 2.0; methyl hydroxypropyl cellulose (MHPC) which has an average degree of substitution DS_{methyl} of 1.2 to 2.2, preferably 1.3 to 2.0, and preferably a molecular degree of substitution MS_{hydroxypropyl} of 0.1 to 1.0, more preferably 0.15 to 0.7;

methyl hydroxyethyl cellulose (MHEC) which has an average degree of substitution DS_{methyl} of 1.2 to 2.2, preferably 1.4 to 1.9, and preferably a molecular degree of substitution MS_{hydroxyethyl} of 0.05 to 0.4, particularly preferably 0.1 to 0.35;
hydroxyethyl cellulose (HEC) which has an average degree of substitution MS_{hydroxyethyl} of 1.2 to 4.0, preferably 1.6 to 3.5;
ethyl hydroxyethyl cellulose (EHEC) which has an average degree of substitution DS_{ethyl} of 0.5 to 1.5, and preferably a molecular degree of substitution MS_{hydroxyethyl} of 1.5 to 3.5;
methyl ethyl hydroxyethyl cellulose (MEHEC) which has an average degree of substitution DS_{methyl} of 0.2 to 2.0 and an average degree of substitution DS_{ethyl} of 0.05 to 1.5 and preferably a molecular degree of substitution MS_{hydroxyethyl} of 0.2 to 3.5;
carboxymethyl cellulose ether (CMC) which has an average degree of substitution DS_{carboxymethyl} of 0.4 to 1.0;
carboxymethyl hydroxyethyl cellulose ether (CMHEC) which has an average degree of substitution DS_{carboxymethyl} of 0.1 to 1.0 and preferably a molecular degree of substitution MS_{hydroxyethyl} of 0.8 to 3.5;
carboxymethyl hydroxypropyl cellulose ether (CMHPC) which has an average degree of substitution DS_{carboxymethyl} of 0.1 to 1.0 and preferably a molecular degree of substitution MS_{hydroxypropyl} of 0.8 to 3.3;
carboxymethyl methyl cellulose ether (CMMC) which has an average degree of substitution DS_{carboxymethyl} of 0.005 to 1.0 and preferably has an average degree of substitution DS_{methyl} of 0.2 to 2.0;
carboxymethyl methyl hydroxyethyl cellulose ether (CMMHEC) which has an average degree of substitution DS_{carboxymethyl} of 0.005 to 1.0 and an average degree of substitution DS_{methyl} of 0.2 to 2.0; and preferably has a molecular degree of substitution MS_{hydroxyethyl} of 0.8 to 3.5;
carboxymethyl methyl hydroxypropyl cellulose ether (CMMHPC), which has an average degree of substitution DS_{carboxymethyl} of 0.005 to 1.0 and an average degree of substitution DS_{methyl} of 0.2 to 2.0; and preferably has a molecular degree of substitution MS_{hydroxypropyl} of 0.8 to 3.3;
sulfoethyl methyl hydroxyethyl cellulose ether (SEMHEC) which has an average degree of substitution DS_{sulfoethyl} of 0.005 to 0.01 and an average degree of substitution DS_{methyl} of 0.2 to 2.0, and preferably a molecular degree of substitution MS_{hydroxyethyl} of 0.1 to 0.3;
sulfoethyl methyl cellulose ether (SEMC) which has an average degree of substitution DS_{sulfoethyl} of 0.005 to 0.01, and preferably an average degree of substitution DS_{methyl} of 0.2 to 2.0;
sulfoethyl methyl hydroxypropyl cellulose ether (SEMHPC) which has an average degree of substitution DS_{sulfoethyl} of 0.005 to 0.01, an average degree of substitution DS_{methyl} of 0.2 to 2.0, and preferably a molecular degree of substitution MS_{hydroxypropyl} of 0.1 to 0.3 and/or
methyl hydroxyethyl hydroxypropyl cellulose ether (MHEHPC) which has an average degree of substitution DS_{methyl} from 1.2 to 2.0, preferably 1.4 to 1.8, and preferably a molecular degree of substitution MS_{hydroxyethyl} from 0.1 to 1.0, particularly preferably 0.3 to 0.5, and preferably has a molecular degree of substitution MS_{hydroxypropyl} from 0.1 to 1.0, more preferably from 0.15 to 0.7.

The polysaccharide or a derivative thereof is preferably selected from guar gum, guar ether, locust bean gum, carrageenan and pectin.

In a preferred embodiment, the cellulose ether and/or the polysaccharide, in particular the cellulose ether, has a water solubility of at least 2 g/l water at 20° C., more preferably at least 5 g/l water.

The cellulose ether preferably has an average degree of polymerisation of 10-5,000. The degree of polymerisation is measured according to pulps in accordance with ISO 5351, “Determination of limiting viscosity number in cupri-ethylenediamine (CED) solution”.

The viscosity of the cellulose ethers is preferably 1-500,000 mPa s, more preferably 3-300,000 mPa s, even more preferably 6-60,000 mPa s measured according to Höppler; 2% solution, 20° C., 20° dH.

The fatty alcohol or the dimer or trimer (component (ii)) is preferably of synthetic or natural origin. Natural fatty alcohols are preferably produced from vegetable or animal fats. Synthetic fatty alcohols are produced by processes familiar to a person skilled in the art. Synthetically produced fatty alcohols also comprise so-called oxo alcohols.

The fatty alcohol is preferably a C₆₋₃₀ alkanol, C₆₋₃₀ alkenol, C₆₋₃₀ alkanedienol, C₆₋₃₀ alkanetrienol or oxo-C₆₋₃₀-alcohol, more preferably a C₁₂₋₂₂ alkanol, C₁₂₋₂₂ alkenol, C₁₂₋₂₂ alkanedienol or C₁₂₋₂₂ alkanetrienol. In the context of the present invention, an “alkane” is a hydrocarbon radical which can be either straight-chain or branched. Straight-chain hydrocarbon radicals are preferably used. The fatty alcohol is preferably a primary alcohol. C═C double bonds in the alkanedienol or alkanetrienol can be distributed alternately or randomly.

Component (i) and component (ii) together have a residual moisture content of 0-20 wt. %, preferably 0-15 wt. %, even more preferably 0.01-10 wt. %, based on the total mass of the components (i) and (ii).

In a preferred embodiment, the weight ratio of component (i) to component (ii) is in the range of 1:15 to 15:1, preferably 1:4 to 4:1. In a preferred embodiment, the weight ratio of component (i) to component (ii) in the preparation is in the range of 1:15 to 15:1, preferably 1:8 to 8:1, more preferably 1:6 to 6:1, more preferably 1:5 to 5:1 and most preferably 1:4 to 4:1.

The proportion of components (i) and (ii) in the total preparation is preferably between 0.1-100 wt. %, more preferably 0.1-1.0 wt. %, even more preferably 0.2-0.5 wt. %, based on the total mass of the preparation. The proportion of components (i) and (ii) in the total preparation is preferably between 0.1-0.5 wt. %, more preferably 0.2-0.4 wt. %, provided that the preparation contains components (iii) and (iv). If the preparation only comprises components (i) and (ii) (and therefore not components (iii) and (iv)), the proportion of these components is preferably 80-100 wt. %, more preferably 90-100 wt. %, based on the total mass of the preparation.

In one embodiment, the proportion of components (i) and (ii) in the preparation is 60-100 wt. %, preferably 65-100 wt. %, more preferably 70-100 wt. %, more preferably 75-100 wt. %, more preferably 80-100 wt. %, more preferably 85-100 wt. %, more preferably 90-100 wt. %, even more preferably 92-100 wt. %, based on the total mass of the preparation.

In a preferred embodiment, the proportion of components (i) and (ii) in the preparation is 60-100 wt. %, preferably 65-100 wt. %, based on the total mass of the preparation, and the weight ratio of component (i) to component (ii) is in the range of 1:4 to 4:1.

The preparation can also contain at least one hydraulic binder. Cement, quicklime, pozzolan, trass and gypsum, preferably cement, are used as hydraulic binders.

The preparation can also contain at least one aggregate. Sand, gravel and/or synthetic fillers are preferably used as suitable aggregates.

The preparation can also contain a further component (v) which comprises at least one additional cellulose ether. Additional cellulose ethers are preferably methyl hydroxyethyl cellulose ether and methyl hydroxypropyl cellulose ether.

In a preferred embodiment, the preparation is formulated as a dry mortar, tile adhesive, plaster system, spackling paste and dry mortar for thermal insulation composite systems. In this case, in addition to components (i) to (iv), the preparation can also contain other auxiliaries known to a person skilled in the art, such as dispersion powder, starch derivatives, cement accelerators, inorganic thickeners, fibres, defoamers and air-entraining agents.

Another aspect of the present invention relates to a method for producing the preparation according to the invention, comprising the steps of
(a) mixing at least one cellulose ether and/or at least one polysaccharide or a derivative thereof, at least one fatty alcohol or dimer or trimer thereof, and at least one solvent,
(b) treating the mixture obtained after step (a) under shear stress, optionally at elevated temperatures,
(c) drying and optionally comminuting the mixture obtained after step (b) and
(d) optionally mixing the mixture obtained after step (c) with at least one hydraulic binder and optionally with at least one aggregate.

Water is preferably used as the solvent in step (a).

A dispersion, preferably an emulsion, particularly preferably an oil-in-water emulsion of fatty alcohol in water is preferably used in step (a). The suspension, in particular the emulsion, preferably has a fatty alcohol content of 5-40 wt. %, based on the total mass of the emulsion.

Step (b) of the method according to the invention preferably takes place with stirring or kneading. Step (b) can take place at elevated temperatures, in particular at temperatures between 20-45° C., particularly preferably at 25-40° C.

The method can be differentiated into embodiments in which the components in step (b) are completely dissolved (variant 1) and in which the fatty alcohol or the dimer or trimer thereof is kneaded into the cellulose ether and/or the polysaccharide in the presence of the solvent (variant 2). In the latter case, the fatty alcohol emulsion is preferably kneaded into the cellulose ether and/or the polysaccharide until it is completely wetted. The respective mixing ratios of cellulose ether/polysaccharide, fatty alcohol and water can be set depending on the type of fatty alcohol and cellulose ether/polysaccharide, with the proviso that the weight ratio of component (i) to component (ii) (in the dry state in each case) is preferably in the range of 1:15 to 15:1, preferably 1:4 to 4:1.

The proportion of cellulose ether and/or polysaccharide in the preparation according to variant 1 is preferably 5-50 wt. %, more preferably approximately 25-45 wt. %, even more preferably approximately 30-35 wt. %, based on the total weight of cellulose ether and/or polysaccharide and fatty alcohol (dry). The proportion of cellulose ether and/or polysaccharide in the preparation according to variant 2 is preferably approximately 50-99.9 wt. %, preferably approximately 70-95 wt. %, even more preferably approximately 80-90 wt. %, based on the total weight of components (i) and (ii) (dry).

The proportion of fatty alcohol (dry) in the preparation according to the invention according to variant 1 is preferably 50-95 wt. %, more preferably 55-75 wt. %, even more preferably 65-70 wt. %, based on the total weight of the components (i) and (ii) (dry).

The proportion of fatty alcohol (dry) in the preparation according to the invention according to variant 2 is preferably approximately 0.1-50 wt. %, more preferably approximately 5-30 wt. %, even more preferably approximately 10-20 wt. %, based on the total weight of components (i) and (ii) (dry).

Variants 1 and 2 are preferably suitable for cellulose ethers which have a Höppler viscosity of 1-500,000 mPa s, preferably 3-300,000 mPa s, particularly preferably 6-60,000 mPa s.

The subsequent drying of the product obtained after step (b) is preferably carried out at an elevated temperature, in particular in the range of 20-45° C., more preferably 25-40° C., optionally under vacuum. Appropriate drying processes are known to a person skilled in the art. The dried product can optionally also be comminuted and/or sieved by methods known to a person skilled in the art. A free-flowing powder with an average d₅₀ particle size of 0.01 to 1,000 μm is preferably present after step (c).

The residual moisture content of the mixture obtained after step (c) is preferably in the range of 0-20 wt. %, more preferably of 0-15 wt. %, even more preferably of 0.01-10 wt. %, based on the total mass of the mixture.

The present invention also relates to a preparation that can be obtained by the method according to the invention.

In a further aspect, the invention also relates to the use of the preparation according to the invention as a construction material or as an additive for construction materials. The preparation according to the invention is used in particular as an additive for construction materials when the preparation is free from components (iii) and (iv). The additive can be added to construction materials simply by mixing in the dry state. Preferred construction materials are selected from mortar systems, especially for thermal insulation composite systems, spackling pastes, plaster systems and tile adhesives. If the preparation according to the invention is used as an additive, the additive is preferably added to the construction materials in amounts of 0.05-0.6 wt. %, more preferably 0.1-0.5 wt. %, even more preferably 0.15-0.5 wt. %, even more preferably 0.15-0.45 wt. %.

The preparations or additives according to the invention have a surprising effect on the open time, the wetting, the processing time and the pull-off test values in construction materials, in particular cement-based tile adhesives. It is currently assumed that an intimate mixing of cellulose ether and/or polysaccharide and fatty alcohol in the preparations according to the invention allows migration of fatty alcohol to the surface of the construction material during processing. Without being tied to a theory, cellulose ether accumulates due to its surfactant properties between air pores and moist mortar and on the surface of the mortar (Jenni et al. 2004). Cellulose ether can therefore be considered a transport medium. Due to the intimate mixing of cellulose ether and fatty alcohol, the fatty alcohol can be fused with the cellulose ether or can accumulate around cellulose ether particles, the fatty alcohol migrating more easily to the surface and thus being able to develop its positive properties, e.g. extending the wetting time and increasing the open time. The known defoaming effect of fatty alcohols (see U.S. Pat. No. 5,807,502) is another migration opportunity for the cellulose ether mixed with fatty alcohol. As already mentioned, cellulose ether has surfactant properties and accumulates between air pores and damp mortar. Since the defoaming effect of the fatty alcohols can cause air to rise to the mortar surface, the cellulose ether mixed with fatty alcohol can inevitably also migrate more easily to the surface, the fatty alcohol thus contributing to the extension of the wetting time or open time. Surprisingly, no disadvantages such as accelerated or significantly delayed cement reaction or reduced early strengths can be established.

The present invention is illustrated by examples, but is not limited thereto:

### EXAMPLES

Producing the preparations according to the invention:

### Variant 1:

An aqueous emulsion of a mixture of natural C₁₄₋₂₀ fatty alcohols (Loxanol OT 5840; concentration of fatty alcohols in the emulsion: ˜20 wt. %, BASF, Ludwigshafen) was diluted 1:1 with water and stirred using a laboratory stirrer (500 RPM) until a homogeneous solution was achieved. Tylose MOBS 6 P4 was then added to the solution (C1-1a) in a concentration of 5 wt. % while stirring at a higher speed (700 rpm). Another option for incorporating the cellulose ether into the emulsion is to add the cellulose ether directly into the undiluted emulsion (C1-1 b) while stirring using a laboratory stirrer (700 RPM). After the cellulose ether had completely dissolved (approx. 2 h), the solution was poured into a flat mould and dried at 40° C. in both methods. After completely drying, the preparation according to the invention was finely ground using a pestle in a mortar. A free-flowing powder or fine granules were obtained. A preparation according to the invention was also produced with Tylose MH 50 G4, which is referred to below as C1-2, in an analogous manner.

### Variant 2:

Loxanol OT 5840 was kneaded into a cellulose ether, here Tylose MHF 15000 P4, in a ratio of 1:1 using a laboratory kneader. The kneading process took approx. 60 minutes. The mixture was then dried at approx. 40° C. under vacuum. The obtained preparation according to the invention was in the form of a free-flowing powder and is referred to below as C2-1.

In the following, percentages should be understood as percentages by weight, unless stated otherwise or evident from the context. “Abs. dry” stands for “absolutely dry” and “AD” for “air dry”. The following components were used:

### Cellulose Ether (CE):

CE1: Tylose MOBS 6 P4, MHPC, DS 1.8, MS 0.28, viscosity (2% abs. dry, 20° C., Ubbelohde) 4.8-7.2 m Pa s
Fine powder (air jet sieve, <0.125 mm: 95%, <0.063 mm: 50%)
CE2: Tylose MH 50 G4, MHEC, DS 1.5, MS 0.2, viscosity (2.85% abs. dry, 20° C., 20° dH, Brookfield RV, spindle 1) 150-250 mPa s
Granules (air jet sieve, <0.5 mm: 95%, <0.125 mm: 30%)
CE3: Tylose MHF 15000 P4, MHEC, DS 1.7, MS 0.2, viscosity (1.9% abs. dry, 20° C., 20° dH, Brookfield RV, spindle 5) 11,000-15,000 mPa s fine powder (air jet sieve, <0.125 mm: 90%, <0.100 mm: 70%)
CE4: Tylose MHF 10015 P4, MHEC, DS 1.7, MS 0.2, viscosity (1.9% abs. dry, 20° C., 20° dH, Brookfield RV, spindle 5) 8,000-12,000 mPa s fine powder (air jet sieve, <0.125 mm: 90%, <0.100 mm: 70%)

### Fatty Alcohol and Cellulose Ether-Fatty Alcohol Compound:

FA on carrier (reference 1): Loxanol OT 5900 (commercial product from BASF Ludwigshafen), fatty alcohol absorbed on a siliceous carrier substance, in powder form, density at 20° C.: ˜0.64 g/cm³, active content of fatty alcohol: ˜44%
FAE (reference 2): Loxanol OT 5840 (commercial product from BASF Ludwigshafen), fatty alcohol emulsion, density at 20° C.: ˜1 g/cm³; dyn. viscosity at 23° C.: ˜600 mPa s; active content of fatty alcohol: ˜20%
C1-1a, C1-1b and C1-2: Cellulose ether-fatty alcohol preparation of variant 1, in powder form
C2-1: Cellulose ether-fatty alcohol preparation of variant 2, in powder form

FA on carriers and FAE are the reference materials for the preparation according to the invention of variants 1 and 2. As already mentioned, both substances are commercially available products from BASF, which are used, inter alia, to extend the open time in mortar or dispersion-bound systems.

Both products are characterised by a certain active content of fatty alcohol, as is the preparation according to the invention of variants 1 and 2. The concentrations of both references are selected such that they correspond to the active content of fatty alcohol in the preparation according to the invention of variants 1 and 2.

All tile adhesive mixtures (hereinafter referred to as FK) contain either unmodified cellulose ether, Tylose MHF 15000 P4, or modified cellulose ether, Tylose MHF 10015 P4, in a concentration of 0.4 wt. %. In addition to these cellulose ethers, the tile adhesive mixtures contain either reference 1, reference 2, reference 3 or the preparation according to the invention of variants 1 and 2.

The following tile adhesive mixtures contain reference 1:

FK 5, FK 6, FK 7, FK 17, FK 21, FK 22, FK 23, FK 31, FK 32 and FK 33 Reference 1 was also used in a higher concentration, as recommended by BASF (0.5-2 wt. %, based on the entire formulation), which is represented by mixture FK 4, FK 20 and FK 30.

The following tile adhesive mixtures contain reference 2:

### FK 8, FK 9, FK 10, FK 18, FK 24, FK 25, FK 26, FK 34, FK 35 and FK 36

While reference 1 could be added to the dry mortar mixture, reference 2 was added to the mixing water of the dry mortar and stirred for a few minutes. It was not possible to add reference 2 directly to the dry mortar.

Further references, reference 3 and reference 4, represent mixtures FK 2 and FK 3, which, in addition to the actual cellulose ether, contain the cellulose ether that is used in the preparations according to the invention of variant 1; Tylose MOBS 6 P4 or MH 50 G4. The concentration of these cellulose ethers is also adapted to the cellulose ethers contained in preparation of variant 1.

Reference 3 and reference 4 were also used together with reference 1 or reference 2 in order to be able to include or exclude symbiotic effects.

As can be seen, the concentrations of the references are chosen so that they are comparable with the preparations according to the invention of variants 1 and 2. This allows the advantages provided by the preparations according to the invention of variants 1 and 2 to be verified.

### Test Products

TABLE 1
Compositions of the powdered preparation of variant 1 C1-1a,
C1-1b, C1-2 and C2-1 of variant 2 (data in parts by weight)

| Product no. | C1-1a | C1-1b | C1-2 | C2-1 |
|---|---|---|---|---|
| CE 1 | 33 | 33 | | |
| CE 2 | | | 33 | |
| CE 3 | | | | 80 |
| Fatty alcohol | 67 | 67 | 67 | 20 |
| Loxanol OT5840 | | | | |
| dry weight | | | | |

### Test Formulations

TABLE 2
Compositions of the test mixtures (parts by weight) with unmodified cellulose
ether MHF 15000 P4, FA on carrier (fatty alcohol emulsion on siliceous carrier;
reference 1) and FAE (fatty alcohol emulsion; reference 2) calculated with
respect to the active content of fatty alcohol in the emulsion

| | | References | | | | | | |
|---|---|---|---|---|---|---|---|---|
| | | 3 | 4 | 1 | 1 | 1 + 3 | 1 + 4 | 2 |
| Test mixture | FK 1 | FK 2 | FK 3 | FK 4 | FK 5 | FK 6 | FK 7 | FK 8 |
| Cement CEM I 52.5N | 38 | 38 | 38 | 38 | 38 | 38 | 38 | 38 |
| Limestone powder 0.1 mm | 5 | 5 | 5 | 5 | 5 | 5 | 5 | 5 |
| Quartz sand 0.1-0.5 mm | 57 | 57 | 57 | 57 | 57 | 57 | 57 | 57 |
| Tylose MHF 15000 P4 | 0.4 | 0.4 | 0.4 | 0.4 | 0.4 | 0.4 | 0.4 | 0.4 |
| Tylose MOBS 6 P4 | | 0.066 | | | | 0.066 | | |
| Tylose MH 50 G4 | | | 0.066 | | | | 0.066 | |
| FA on carrier | | | | 1.2 | 0.305 | 0.305 | 0.305 | |
| FAE | | | | | | | | 0.667 |
| C1-1a | | | | | | | | |
| C1-1b | | | | | | | | |
| C1-2 | | | | | | | | |
| Water | 23 | 23 | 23 | 23 | 23 | 23 | 23 | 23 |

| | References | | | | | | |
|---|---|---|---|---|---|---|---|
| | 2 + 3 | 2 + 4 | | | | | |
| Test mixture | FK 9 | FK 10 | FK 11 | FK 12 | FK 13 | FK 14 | FK 15 |
| Cement CEM I 52.5N | 38 | 38 | 38 | 38 | 38 | 38 | 38 |
| Limestone powder 0.1 mm | 5 | 5 | 5 | 5 | 5 | 5 | 5 |
| Quartz sand 0.1-0.5 mm | 57 | 57 | 57 | 57 | 57 | 57 | 57 |
| Tylose MHF 15000 P4 | 0.4 | 0.4 | 0.4 | 0.4 | 0.4 | 0.335 | 0.335 |
| Tylose MOBS 6 P4 | 0.066 | | | | | | |
| Tylose MH 50 G4 | | 0.066 | | | | | |
| FA on carrier | | | | | | | |
| FAE | 0.667 | 0.667 | | | | | |
| C1-1a | | | 0.2 | | | 0.165 | |
| C1-1b | | | | 0.2 | | | |
| C1-2 | | | | | 0.2 | | 0.165 |
| Water | 23 | 23 | 23 | 23 | 23 | 23 | 23 |

### Test Formulations

TABLE 3
Compositions of the test mixtures (parts by weight) with unmodified
cellulose ether MHF 15 000 P4, FA on carrier (fatty alcohol
emulsion on siliceous carrier; reference 1) and FAE (fatty
alcohol emulsion; reference 2) calculated with respect to
the active content of fatty alcohol in the emulsion

References

| | | 1 | 2 |
|---|---|---|---|
| Test mixture | FK 16 | FK 17 | FK18 |
| Cement CEM I 52.5N | 38 | 38 | 38 |
| Limestone powder 0.1 mm | 5 | 5 | 5 |
| Quartz sand 0.1-0.5 mm | 57 | 57 | 57 |
| Tylose MHF 15000 P4 | | 0.4 | 0.4 |
| FA on carrier | | 0.25 | |
| FAE | | | 0.55 |
| C2-1 | 0.5 | | 20 |
| Water | 23 | 23 | 23 |

### Test Formulations

TABLE 4
Compositions of the test mixtures (parts by weight) with modified cellulose ether MHF 10015 P4, FA on carrier
(fatty alcohol emulsion on siliceous carrier; reference 1) and FAE (fatty alcohol emulsion; reference 2)
calculated with respect to the active content of fatty alcohol in the emulsion, with 30 wt. % water

| | | References | | | | | | | | |
|---|---|---|---|---|---|---|---|---|---|---|
| | | 1 | 1 | 1 + 3 | 1 + 4 | 2 | 2 + 3 | 2 + 4 | | |
| Test mixture | FK 19 | FK 20 | FK 21 | FK 22 | FK 23 | FK 24 | FK 25 | FK 26 | FK 27 | FK 28 |
| Cement CEM I 52.5 | 38 | 38 | 38 | 38 | 38 | 38 | 38 | 38 | 38 | 38 |
| Limestone powder 0.1 mm | 5 | 5 | 5 | 5 | 5 | 5 | 5 | 5 | 5 | 5 |
| Quartz sand 0.1-0.5 mm | 57 | 57 | 57 | 57 | 57 | 57 | 57 | 57 | 57 | 57 |
| Vinnapas 5028E | 5 | 5 | 5 | 5 | 5 | 5 | 5 | 5 | 5 | 5 |
| Tylose MHF 10015 P4 | 0.4 | 0.4 | 0.4 | 0.4 | 0.4 | 0.4 | 0.4 | 0.4 | 0.4 | 0.4 |
| Tylose MOBS 6 P4 | | | | 0.066 | | | 0.066 | | | |
| Tylose MH 50 G4 | | | | | 0.066 | | | 0.066 | | |
| FA on carrier | | 1.2 | 0.305 | 0.305 | 0.305 | | | | | |
| FAE | | | | | | 0.667 | 0.667 | 0.667 | | |
| C1-1a | | | | | | | | | 0.2 | |
| C1-2 | | | | | | | | | | 0.2 |
| Water | 30 | 30 | 30 | 30 | 30 | 30 | 30 | 30 | 30 | 30 |

TABLE 5
Compositions of the test mixtures (parts by weight) with modified cellulose ether MHF 10015 P4, FA on carrier
(fatty alcohol emulsion on siliceous carrier; reference 1) and FAE (fatty alcohol emulsion; reference 2)
calculated with respect to the active content of fatty alcohol in the emulsion, with 24 wt. % water

| | | References | | | | | | | | |
|---|---|---|---|---|---|---|---|---|---|---|
| | | 1 | 1 | 1 + 3 | 1 + 4 | 2 | 2 + 3 | 2 + 4 | | |
| Test mixture | FK 29 | FK 30 | FK 31 | FK 32 | FK 33 | FK 34 | FK 35 | FK 36 | FK 37 | FK 38 |
| Cement CEM I 52.5N | 38 | 38 | 38 | 38 | 38 | 38 | 38 | 38 | 38 | 38 |
| Limestone powder 0.1 mm | 5 | 5 | 5 | 5 | 5 | 5 | 5 | 5 | 5 | 5 |
| Quartz sand 0.1-0.5 mm | 57 | 57 | 57 | 57 | 57 | 57 | 57 | 57 | 57 | 57 |
| Vinnapas 5028E | 5 | 5 | 5 | 5 | 5 | 5 | 5 | 5 | 5 | 5 |
| Tylose MHF 10015 P4 | 0.4 | 0.4 | 0.4 | 0.4 | 0.4 | 0.4 | 0.4 | 0.4 | 0.4 | 0.4 |
| Tylose MOBS 6 P4 | | | | 0.066 | | | 0.066 | | | |
| Tylose MH 50 G4 | | | | | 0.066 | | | 0.066 | | |
| FA on carrier | | 1.2 | 0.305 | 0.305 | 0.305 | | | | | |
| FAE | | | | | | 0.667 | 0.667 | 0.667 | | |
| C1-1a | | | | | | | | | 0.2 | |
| C1-2 | | | | | | | | | | 0.2 |
| Water | 24 | 24 | 24 | 24 | 24 | 24 | 24 | 24 | 24 | 24 |

Furthermore, tests for producing the preparations according to the invention of variant 1 were carried out with high-viscosity cellulose ethers, the preparations also being tested for suitability with regard to wetting time in the same tile adhesive formulation. The cellulose ethers had to be stirred into the alcohol emulsion in a lower concentration, depending on their viscosity, since homogenisation was not possible at a concentration of 5%.

The following cellulose ethers were used:

CE 5: Tylose MH 15000 YP4, MHEC delayed swelling, DS 1.6, MS 0.15, viscosity (1.9% abs. dry, 20° C., 20° dH, Brookfield RV, spindle 5) 11,000-15,000 mPa s
Fine powder (air jet sieve, <0.125 mm: 90%, <0.100 mm: 70%)
CE 6: Tylose H 60000 YP2, HEC, MS 2.0, viscosity (1.0% abs. dry, 25° C., distilled water, Brookfield LV, spindle 3) 2,600-3,400 mPa s
Fine powder (air jet sieve, <0.180 mm: 85%)
CE7: Tylose MHF 100000 P4, MHEC, DS 1.7, MS 0.2, viscosity (1.0% abs. dry, 20° C., 20° dH, Brookfield RV, spindle 4) 4,100-5,500 mPa s
Fine powder (air jet sieve, <0.125 mm: 90%, <0.100 mm: 70%)
CE 8: Tylose MHS 300000 P3, MHEC, DS 1.7, MS 0.25, viscosity (1.0% abs. dry, 20° C., 20° dH, Brookfield RV, spindle 5) 8,000-11,000 mPa s
Fine powder (air jet sieve, <0.125 mm: 75%, <0.063 mm: <40%)

### Test Products

TABLE 6
Compositions of the powdered preparations of variant 1 C1-1a,
C1-1b, C1-2 and C2-1 of variant 2 (data in parts by weight)

| Product no. | C1-3 | C1-4 | C1-5 | C1-6 |
|---|---|---|---|---|
| CE 5 | 12 | | | |
| CE 6 | | 12 | | |
| CE 7 | | | 6 | |
| CE 8 | | | | 6 |
| Fatty alcohol Loxanol | 88 | 88 | 94 | 94 |
| OT5840 dry weight | | | | |

### Test Formulations

TABLE 7
Compositions of the test mixtures (parts by weight) with unmodified
cellulose ether MHF 15 000 P4, FA on carrier (fatty alcohol
emulsion on siliceous carrier; reference 1) and FAE (fatty
alcohol emulsion; reference 2) calculated with respect to
the active content of fatty alcohol in the emulsion

| Test mixture | FK 39 | FK 40 | FK 41 | FK 42 |
|---|---|---|---|---|
| Cement CEM I 52.5N | 38 | 38 | 38 | 38 |
| Limestone powder 0.1 mm | 5 | 5 | 5 | 5 |
| Quartz sand 0.1-0.5 mm | 57 | 57 | 57 | 57 |
| Tylose MHF 15000 P4 | 0.4 | 0.4 | 0.4 | 0.4 |
| C1-3 | 0.2 | | | |
| C1-4 | | 0.2 | | |
| C1-5 | | | 0.2 | |
| C1-6 | | | | 0.2 |
| Water | 23 | 23 | 23 | 23 |

### Test Methods for Tile Adhesive

Open time according to ISO 13007 and DIN EN 1346 and storage tests according to DIN EN 1348 or DIN EN 12004.

The tile adhesives described in tables 2 and 3 were mixed with water to form a mortar, and 100 parts by weight of the described formulations were mixed with 23 parts by weight of mixing water for the tests with the unmodified Tylose MHF 15000 P4, and with 24 or 30 parts by weight of mixing water for the tests with the modified Tylose MHF 10015 P4.

The modified cellulose ether is used in high-quality tile adhesives (C2TE (S1)). The water requirement is normally quite high due to the high level of modification of the cellulose ether. In order to ensure the stability T according to DIN EN 1308 of the tile adhesive (0.5 mm to reach T), the water requirement had to be reduced to 24 parts by weight when using the preparation according to the invention. First, the mixture was stirred for 30 seconds on the lowest setting, then left to mature for 1 minute, again stirred for 1 minute, allowed to mature for 5 minutes and finally sheared again for 15 seconds on a low setting. The mortar was then applied to a concrete slab using a notched trowel (according to ISO 13007). The wetting was measured by laying earthenware tiles (5×5 cm) in the mortar bed every 5 minutes, weighting them down with 2 kg for 30 seconds and then removing them from the mortar bed. The wetting of the back of the tiles was given in %. A wetting of ≥50% of the back of the tiles must be achieved for the open time or wettability to be considered good. FIG. 1 illustrates how the wetting was measured.

The open time E for tile adhesive is determined in accordance with DIN EN 1346 or DIN EN 12004 by applying the tile adhesive to a defined concrete slab (here Solana) using a notched trowel. 10, 20, 30, 40, 50 and 60 minutes after applying the mortar, 4-8 earthenware tiles per unit of time are laid in the mortar bed and weighted down with a 2 kg weight for 30 seconds. After the last earthenware tiles have been applied to the mortar bed after 60 minutes, the slabs are stored for 28 days in a standard climate (23° C. and 50% air humidity). After storage, the pull-off test values are determined, which involves tearing the tiles off the concrete slab using a pull-off tester (Herion). The pull-off test values must reach ≥0.5 N/mm² after 30 minutes in order to meet the standard for a C1/C2 E adhesive. The determined values are listed in tables 6 and 8.

The pull-off test values of the different storage types were also determined according to DIN EN 1348 and DIN EN 12004. The adhesive values must be ≥0.5 N/mm² for a C1 adhesive and ≥1.0 N/mm² for a C2 adhesive. The values listed in tables 7 and 9 represent the pull-off test values after dry storage or standard storage (28 days at 23° C. and 50% air humidity), hot storage (14 days standard climate, 14 days at 70° C.) and water storage (1 week standard climate, three weeks in standard temperature water).

TABLE 8
Results of the wetting [%] of tile adhesives with and without the preparation
according to the invention of variant 1 and variant 2 and the references thereof

| | | References | | | | | | | | | |
|---|---|---|---|---|---|---|---|---|---|---|---|
| | | 3 | 4 | 1 | 1 | 1 + 3 | 1 + 4 | 2 | 2 + 3 | 2 + 4 | |
| Test mixture | FK 1 | FK 2 | FK 3 | FK 4 | FK 5 | FK 6 | FK 7 | FK 8 | FK 9 | FK 10 | FK 11 |
| Wetting 10 minutes | 80 | 95 | 90 | 95 | 95 | 95 | 90 | 95 | 95 | 95 | 95 |
| Wetting 15 minutes | 45 | 90 | 80 | 90 | 85 | 90 | 85 | 95 | 95 | 90 | 95 |
| Wetting 20 minutes | | 45 | 50 | 85 | 40 | 70 | 65 | 90 | 85 | 90 | 90 |
| Wetting 25 minutes | | | 35 | 70 | | 55 | 55 | 90 | 85 | 90 | 85 |
| Wetting 30 minutes | | | | 45 | | 40 | 45 | 85 | 80 | 80 | 80 |
| Wetting 35 minutes | | | | | | | | 80 | 75 | 75 | 80 |
| Wetting 40 minutes | | | | | | | | 75 | 70 | 65 | 75 |
| Wetting 45 minutes | | | | | | | | 70 | 65 | 65 | 75 |
| Wetting 50 minutes | | | | | | | | 60 | 65 | 60 | 75 |
| Wetting 55 minutes | | | | | | | | 45 | 40 | 45 | 70 |
| Wetting 60 minutes | | | | | | | | | | | 65 |

| | | | | | | References | |
|---|---|---|---|---|---|---|---|
| | | | | | | 1 | 2 |
| Test mixture | FK 12 | FK 13 | FK 14 | FK 15 | FK 16 | FK 17 | FK 18 |
| Wetting 10 minutes | 95 | 95 | 100 | 100 | 100 | 80 | 95 |
| Wetting 15 minutes | 95 | 95 | 100 | 100 | 95 | 60 | 95 |
| Wetting 20 minutes | 95 | 95 | 100 | 100 | 95 | 60 | 90 |
| Wetting 25 minutes | 95 | 90 | 100 | 95 | 90 | 20 | 85 |
| Wetting 30 minutes | 90 | 85 | 95 | 95 | 90 | | 80 |
| Wetting 35 minutes | 85 | 80 | 95 | 95 | 90 | | 80 |
| Wetting 40 minutes | 80 | 80 | 95 | 95 | 90 | | 70 |
| Wetting 45 minutes | 75 | 75 | 95 | 90 | 90 | | 70 |
| Wetting 50 minutes | 70 | 65 | 85 | 90 | 85 | | 60 |
| Wetting 55 minutes | 70 | 65 | 75 | 80 | 80 | | 40 |
| Wetting 60 minutes | 65 | 50 | 75 | 65 | 70 | | |

Mixture FK 1 contained only unmodified Tylose MHF 15000 P4 and displayed the lowest wetting. After 15 minutes, only 45% of the back of the tile was covered with mortar. The same applied to mixtures FK 2 and FK 3, which, in addition to the unmodified Tylose MHF 15000 P4, also contained reference 3 or reference 4 in the concentration as contained in 0.2 wt. % of the preparation according to the invention of variant 1. The wetting was somewhat better than for mixture FK 1, with a wetting time of 15 minutes being achieved.

Mixture FK 4 also contained reference 1 in an amount of 1.2 wt. % in addition to the unmodified Tylose MHF 15000 P4. The mixture showed good wetting up to 25 minutes, but after 30 minutes it no longer produced the desired 50% wetting of the back of the tile.

In addition to the unmodified Tylose MHF 15000 P4, mixture FK 5 also contained reference 1, but in a lower concentration of 0.305 wt. %. The concentration of the active fatty alcohol was adapted to the concentration of the fatty alcohol as contained in 0.2 wt. % of the preparation of variant 1. The same applied to mixtures FK 6 and FK 7, which additionally contained reference 3 and reference 4 in the concentration as contained in 0.2 wt. % of the preparation according to the invention of variant 1. The wetting of both mixtures was slightly better than for mixture FK 5 and achieved a wetting time of as much as 25 minutes. Mixture FK 5 only lasted 15 minutes. A slightly improving effect of both cellulose ethers could thus be recorded.

In addition to the unmodified Tylose MHF 15000 P4, mixtures FK 8 to FK 10 contained reference 2, which had to be added to the mixing water of the dry mortar beforehand. The wetting of mixture FK 8 was significantly better and reached 60% wetting after 50 minutes, but only 45% after 55 minutes. In addition to reference 2, FK 9 and FK 10 also contained reference 3 and reference 4, respectively, in the concentration as in the preparation of variant 1. Here, too, wetting was of similar quality to that of mixture FK 8.

Mixtures FK 11 to FK 13 contained the preparation according to the invention of variant 1 in addition to the unmodified Tylose MHF 15000 P4. The wetting times of mixtures FK 11 and FK 12 showed similarly excellent values and reached 65% wetting after 60 minutes. Mixture FK 13 also showed good values, but only achieved 50% wetting after 60 minutes.

Mixtures FK 14 and FK 15 were distinguished by the fact that the unmodified cellulose ether MHF 15000 P4 used was mixed with the preparation according to the invention of variant 1 before it was added to the dry mortar. The concentration of the preparation according to the invention was somewhat lower; it contained 0.165 wt. % instead of 0.2 wt. %. The wetting time here was also longer than 60 minutes, with the back of the tile being completely wetted up to 25 minutes.

Mixture FK 16 contained the preparation according to the invention of variant 2 and was again able to achieve better wetting times than the mixtures with the preparation according to the invention of variant 1. After 60 minutes, wetting was still 70% (FIG. 1).

In addition to the unmodified Tylose MHF 15000 P4, mixture FK 17 also contained reference 1. The concentrations of both substances were adapted to the concentrations of cellulose ether and fatty alcohol as in 0.5 wt. % of the preparation according to the invention of variant 2. The wetting times were comparable with mixture FK 5.

In addition to the unmodified Tylose MHF 15000 P4, mixture FK 18 also contained reference 2. Here too, the concentrations of both substances were adapted to the concentrations of cellulose ether and fatty alcohol as in 0.5 wt. % of the preparation according to the invention of variant 2. The wetting times were as good as those of mixture FK 8.

In general, longer wetting of over an hour can be achieved by using the preparation according to the invention of variants 1 and 2. Compared with the mixtures containing references 1 and 2 (fatty alcohol on a siliceous carrier material and liquid fatty alcohol emulsion), the wetting times were longer and the back of the tile was wetted by tile adhesive over a larger area.

TABLE 9
Results of the wetting [%] of tile adhesives with and without the
preparation according to the invention of variant 1 and the references thereof

| | | References | | | | | | | | | |
|---|---|---|---|---|---|---|---|---|---|---|---|
| | | 1 | 1 | 1 + 3 | 1 + 4 | 2 | 2 + 3 | 2 + 4 | | | |
| Test mixture | FK 19* | FK 20* | FK 21* | FK 22* | FK 23* | FK 24* | FK 25* | FK 26* | FK 27* | FK 28* | FK 29′ |
| Wetting 10 minutes | 100 | 90 | 95 | 100 | 95 | 100 | 95 | 100 | 100 | 100 | 95 |
| Wetting 15 minutes | 95 | 85 | 95 | 95 | 95 | 100 | 95 | 95 | 100 | 100 | 65 |
| Wetting 20 minutes | 90 | 55 | 95 | 95 | 75 | 95 | 90 | 95 | 100 | 100 | 45 |
| Wetting 25 minutes | 80 | 50 | 90 | 90 | 70 | 95 | 90 | 90 | 95 | 100 | |
| Wetting 30 minutes | 75 | 40 | 80 | 90 | 65 | 95 | 75 | 85 | 95 | 95 | |
| Wetting 35 minutes | 65 | | 75 | 80 | 65 | 90 | 75 | 75 | 95 | 95 | |
| Wetting 40 minutes | 55 | | 70 | 70 | 60 | 85 | 75 | 70 | 90 | 95 | |
| Wetting 45 minutes | 50 | | 50 | 55 | 55 | 80 | 75 | 70 | 90 | 90 | |
| Wetting 50 minutes | 45 | | 45 | 40 | 55 | 70 | 55 | 60 | 85 | 90 | |
| Wetting 55 minutes | | | | | 40 | 65 | 55 | 50 | 80 | 85 | |
| Wetting 60 minutes | | | | | | 55 | 50 | 45 | 80 | 85 | |

| | References | | | | | | | | |
|---|---|---|---|---|---|---|---|---|---|
| | 1 | 1 | 1 + 3 | 1 + 4 | 2 | 2 + 3 | 2 + 4 | | |
| Test mixture | FK 30′ | FK 31′ | FK 32′ | FK 33′ | FK 34′ | FK 35′ | FK 36′ | FK 37′ | FK 38′ |
| Wetting 10 minutes | 55 | 90 | 95 | 80 | 95 | 90 | 90 | 95 | 95 |
| Wetting 15 minutes | 40 | 75 | 95 | 75 | 90 | 85 | 90 | 95 | 95 |
| Wetting 20 minutes | | 50 | 90 | 70 | 90 | 85 | 90 | 90 | 90 |
| Wetting 25 minutes | | 30 | 85 | 65 | 85 | 80 | 80 | 80 | 80 |
| Wetting 30 minutes | | | 75 | 40 | 75 | 75 | 75 | 75 | 70 |
| Wetting 35 minutes | | | 40 | | 65 | 55 | 65 | 70 | 65 |
| Wetting 40 minutes | | | | | 60 | 50 | 60 | 65 | 60 |
| Wetting 45 minutes | | | | | 55 | 50 | 60 | 60 | 55 |
| Wetting 50 minutes | | | | | 40 | 10 | 20 | 55 | 50 |
| Wetting 55 minutes | | | | | | | | 50 | 45 |
| Wetting 60 minutes | | | | | | | | 45 | |

*with 30 wt. % water
′with 24 wt. % water

Mixtures FK 19 and FK 29 contained the modified Tylose MHF 10015 P4 and dispersion powder at 30 wt. % and 24 wt. % water. Mixture FK 19 with 30 wt. % water showed a good wetting time of 45 minutes. Mixture FK 29 with 24 wt. % water only achieved a wetting time of 15-20 minutes because of the excessively low water content for such a highly modified cellulose ether.

Mixtures FK 20 and FK 30 contained reference 1 in a concentration of 1.2 wt. % in addition to the modified Tylose MHF 10015 P4 and dispersion powder. Mixture FK 20 with 30 wt. % water could not achieve a good wetting time. The impression arose that the use of too high a concentration of reference 1 had a negative effect on the wetting time.

As expected, FK 30 with 24 wt. % water showed a poorer wetting time than FK 20. Here, only 10 minutes were achieved.

Mixtures FK 21 to FK 23 and FK 31 to FK 33 contained reference 1 in addition to the modified Tylose MHF 10015 P4 and dispersion powder. The concentration of the active fatty alcohol here corresponded to the concentration of the active fatty alcohol as in 0.2 wt. % of the preparation of variant 1. In lower concentrations, reference 1 showed a better effect, but no improved wetting time compared with FK 19 and FK 29 without reference 1. Reference 1 may be incompatible with other modifiers. Mixtures FK 22, FK 23, FK 32 and FK 33 also contained reference 3 and 4, Tylose MOBS 6 P4 and MH 50 G4. The concentration of cellulose ether in the mixtures corresponded to the cellulose ether concentration in 0.2 wt. % of the preparation according to the invention. The wetting times for the mixtures with 30 wt. % water were comparable, with references 3 and 4 showing no additional influence on the wetting times. For the mixtures with 24 wt. % water, a slight improvement in the wetting time could also be observed in comparison with mixture FK 31 due to reference 3 and reference 4.

In addition to the modified Tylose MHF 10015 P4 and dispersion powder, mixtures FK 24 to FK 26 and FK 34 to FK 36 contained reference 2, which was added to the mixing water.

The active fatty alcohol content was adjusted such that the active content corresponded to that of the dried emulsion of the preparation of variant 1. Here, too, the mixtures differed in their water content of 30 wt. % and 24 wt. %.

Mixtures FK 25, FK 26, FK 35 and FK 36 also contained reference 3 and reference 4. The concentration of the references, Tylose MOBS 6 P4 and MH 50 G4, in the mixtures also corresponded to the cellulose ether concentration in 0.2 wt. % of the preparation according to the invention here. Mixtures FK 24 to FK 26 with 30 wt. % water displayed a very good wetting time, it being possible for 55% of the back of the tile to still be wetted after 60 minutes. No additional influence of the cellulose ether could be observed. Mixtures FK 34 to FK 36 achieved a wetting time of only 45 minutes with 24 wt. % water. Here, too, there was no influence of the additional references 3 and 4.

Mixtures FK 27, FK 28, FK 37 and FK 38 contained, in addition to the modified Tylose MHF 10015 P4 and dispersion powder, the preparation according to the invention of variant 1 based on Tylose MOBS 6 P4 (FK 27 and 37) and Tylose MH 50 G4 (FK 28 and 38). The mixtures also differed from one another in the water content of 30 wt. % and 24 wt. % here. Mixtures FK 27 and FK 28 with 30 wt. % water displayed a remarkable wetting of the back of the tiles of 80 and 85%, respectively, up to 60 minutes and stood out clearly from all other mixtures. Mixtures FK 37 and FK 38 with 24 wt. % water were able to achieve a wetting time of 50 and 55 minutes, respectively, which was also the best result of all mixtures with the same water content.

The preparation according to the invention of variant 1 in combination with modified cellulose ether also showed the best wetting times for both water factors in comparison with references 1 and 2.

TABLE 10
Results of the wetting [%] of tile adhesives with
the preparation according to the invention of variant
1 based on medium to high viscosity cellulose ethers

| Test mixture | FK 39 | FK 40 | FK 41 | FK 42 |
|---|---|---|---|---|
| Wetting 10 minutes | 95 | 95 | 100 | 100 |
| Wetting 15 minutes | 90 | 90 | 95 | 95 |
| Wetting 20 minutes | 90 | 90 | 95 | 95 |
| Wetting 25 minutes | 90 | 90 | 90 | 95 |
| Wetting 30 minutes | 90 | 85 | 90 | 95 |
| Wetting 35 minutes | 85 | 85 | 85 | 95 |
| Wetting 40 minutes | 75 | 75 | 80 | 90 |
| Wetting 45 minutes | 70 | 70 | 70 | 85 |
| Wetting 50 minutes | 70 | 60 | 70 | 80 |
| Wetting 55 minutes | 60 | 50 | 55 | 80 |
| Wetting 60 minutes | 45 | 35 | 45 | 70 |

As can be seen, the preparations according to the invention with the medium to high viscosity cellulose ethers also achieved very good wetting times. With the preparation C1-6 according to the invention, which contained Tylose MHS 300000 P3, it was possible to achieve wetting of 70% of the back of the tile even after one hour.

TABLE 11
Results of the open time (OT) according to EN 1346 [N/mm²]
of tile adhesives with and without preparations according to
the invention of variant 1 and variant 2 and the references thereof

| | | References | | | | | | | | |
|---|---|---|---|---|---|---|---|---|---|---|
| | | 3 | 4 | 1 | 1 | 1 + 3 | 1 + 4 | 2 | 2 + 3 | 2 + 4 |
| Test mixture | FK 1 | FK 2 | FK 3 | FK 4 | FK 5 | FK 6 | FK 7 | FK 8 | FK 9 | FK 10 |
| OT after 10 minutes | 0.71 | 0.78 | 0.76 | 0.90 | 0.89 | 0.92 | 0.78 | 1.01 | 1.00 | 1.03 |
| OT after 20 minutes | 0.40 | 0.52 | 0.41 | 0.43 | 0.55 | 0.66 | 0.52 | 0.96 | 1.11 | 0.97 |
| OT after 30 minutes | 0.36 | 0.41 | 0.34 | 0.21 | 0.42 | 0.47 | 0.30 | 0.86 | 0.96 | 0.90 |
| OT after 40 minutes | | | | | 0.11 | 0.18 | 0.15 | 0.79 | 0.77 | 0.75 |
| OT after 50 minutes | | | | | | | | 0.59 | 0.67 | 0.66 |
| OT after 60 minutes | | | | | | | | 0.45 | 0.58 | 0.57 |

| | | | | | | References | |
|---|---|---|---|---|---|---|---|
| | | | | | | 1 | 2 |
| Test mixture | FK 11 | FK 12 | FK 14 | FK 15 | FK 16 | FK 17 | FK 18 |
| OT after 10 minutes | 0.96 | 0.99 | 0.89 | 0.99 | 1.33 | 0.74 | 1.09 |
| OT after 20 minutes | 1.15 | 1.16 | 0.85 | 1.00 | 1.10 | 0.49 | 0.92 |
| OT after 30 minutes | 1.00 | 1.01 | 0.89 | 0.99 | 0.96 | 0.34 | 0.84 |
| OT after 40 minutes | 0.91 | 0.92 | 0.78 | 0.72 | 0.80 | 0.12 | 0.75 |
| OT after 50 minutes | 0.81 | 0.77 | 0.68 | 0.69 | 0.65 | | 0.68 |
| OT after 60 minutes | 0.76 | 0.71 | 0.55 | 0.63 | 0.56 | | 0.59 |

TABLE 12
Results of the storage tests according to DIN EN 1348
[N/mm²] of tile adhesives with and without preparations according
to the invention of variant 1 and variant 2 and the references thereof

| | | References | | | | | | | | |
|---|---|---|---|---|---|---|---|---|---|---|
| | | 3 | 4 | 1 | 1 | 1 + 3 | 1 + 4 | 2 | 2 + 3 | 2 + 4 |
| Test mixture | FK 1 | FK 2 | FK 3 | FK 4 | FK 5 | FK 6 | FK 7 | FK 8 | FK 9 | FK 10 |
| Standard | 0.83 | 0.89 | 0.91 | 0.86 | 1.11 | 1.14 | 1.16 | 1.24 | 1.18 | 1.20 |
| Hot | 0.64 | 0.69 | 0.63 | 0.00 | 0.69 | 0.77 | 0.78 | 0.77 | 0.80 | 0.75 |
| Water | 1.19 | 1.28 | 1.20 | 1.05 | 1.36 | 1.49 | 1.24 | 1.80 | 1.83 | 1.82 |

| | | | | | | References | |
|---|---|---|---|---|---|---|---|
| | | | | | | 1 | 2 |
| Test mixture | FK 11 | FK 12 | FK 14 | FK 15 | FK 16 | FK 17 | FK 18 |
| Standard | 1.18 | 1.29 | 1.20 | 1.07 | 1.44 | 1.08 | 1.23 |
| Hot | 0.86 | 0.95 | 0.87 | 0.71 | 0.88 | 0.76 | 0.85 |
| Water | 1.77 | 1.87 | 2.52 | 2.07 | 1.94 | 1.32 | 1.54 |

### Open Time According to DIN EN 1346:

Mixture FK 1 contained only unmodified Tylose MHF 15000 P4 and displayed the lowest pull-off test values, which was to be expected due to the lack of modification. The 30 minutes to be achieved in the standard were not achieved.

The same applies to mixtures FK 2 and FK 3. Here, in addition to unmodified cellulose ether, reference 3 and 4, Tylose MOBS 6 P4 or MH 50 G4 was added so that it was present in the same concentration as in the addition amount for 0.2 wt. % of the preparation according to the invention of variant 1. Here, too, the standard of 0.5 N/mm² after 30 minutes was not met.

In addition to unmodified Tylose MHF 15000 P4, mixture FK 4 contained reference 1 in a concentration of 1.2 wt. %. The pull-off test values were not much higher than for FK1 and did not show any significant improvement in the open time.

Mixture FK 5 also contained reference 1 in addition to the unmodified Tylose MHF 15000 P4. However, the concentration of the active fatty alcohol here is adapted to the fatty alcohol concentration as contained in the amount of 0.2 wt. % of the preparation according to the invention of variant 1. The pull-off test values were not significantly better than with the high concentration of reference 1.

The same applies to mixtures FK 6 and FK 7, which also contained reference 3 and 4, respectively, i.e. the cellulose ethers (Tylose MOBS 6 P4 or MH 50 G4) that were contained in the preparation according to the invention of variant 1. Here, too, the concentration was selected so that it corresponded to the concentration of cellulose ether in 0.2 wt. % of the preparation according to the invention of variant 1.

Mixture FK 8 contained reference 2 in addition to unmodified Tylose MHF 15000 P4. The concentration of the active fatty alcohol also corresponds to the fatty alcohol concentration as contained in 0.2 wt. % of the preparation of variant 1 here. Good pull-off test values of 0.59 N/mm² were still achieved after an open time of 50 minutes, but the values are generally somewhat lower than the values of the mixtures with the preparations according to the invention of variants 1 and 2.

The same applies to mixtures FK 9 and FK 10, which also contained reference 3 and 4, respectively. Here, too, the concentration of reference 3 or 4 was chosen such that it corresponded to the concentration of the cellulose ether in 0.2 wt. % of the preparation according to the invention of variant 1. The adhesive values were somewhat higher after 50 and 60 minutes of open time and still reached 0.58 and 0.57 N/mm² after 60 minutes. A slightly positive effect from the additional reference 3 or 4 could be the cause here.

In addition to the unmodified Tylose MHF 15000 P4, mixtures FK 11 and FK 12 contained the preparation according to the invention of variant 1. Even after 60 minutes, the adhesive values of 0.76 and 0.71 N/mm² met the standard of 0.5 N/mm² after 30 minutes, which was not the case with the previous mixtures with references 1 and 2. Compared with reference 2, the mixtures with the preparation according to the invention of variant 1 above all achieved better adhesive values after an open time of 60 minutes.

Mixtures FK 14 and FK 15 were distinguished by the fact that the unmodified cellulose ether MHF 15000 P4 used was mixed with the preparation according to the invention of variant 1 before it was added to the dry mortar. The concentration of the preparation according to the invention of variant 1 was somewhat lower here at 0.165 wt. % instead of 0.2 wt. %. The adhesive values were also somewhat lower than those of other mixtures, but with values of 0.55 and 0.63 N/mm² 60 minutes they still reached the standard of 0.5 N/mm².

In addition to unmodified Tylose MHF 15000 P4, mixture FK 16 contained the preparation according to the invention of variant 2. Here, too, very good pull-off test values were achieved in the open time. After 60 minutes, values of 0.56 N/mm² were still achieved.

Mixture FK 17 contained reference 1 in addition to unmodified Tylose MHF 15000 P4. The concentration of the active fatty alcohol is adapted to the fatty alcohol concentration as contained in the amount of 0.5 wt. % of the preparation according to the invention of variant 2. The open time was comparable with the previous mixtures containing reference 1.

Mixture FK 18 contained reference 2 in addition to the unmodified cellulose ether. Here, too, the concentration of active fatty alcohol is again adapted to the fatty alcohol concentration as contained in the amount of 0.5 wt. % of the preparation according to the invention of variant 2. The open time was comparable with the mixture containing the preparation of variant 2. A major disadvantage of this mixture, however, is that reference 2 must always be stirred into the mixing water before the dry mortar is added and cannot be added to the dry mortar mixture.

### Storage Types According to DIN EN 1348:

Mixture FK 1, which contained only unmodified Tylose MHF 15000 P4, again displayed the lowest pull-off test values, which was to be expected due to the lack of modification and the absence of dispersion powder. However, the C1 standard of 0.5 N/mm² was achieved. The same applies to mixtures FK 2 and FK 3. As already mentioned, in addition to the unmodified cellulose ether, reference 3 or 4 was added to these mixtures such that it was present in the same concentration as in the addition amount of 0.2 wt. % of the preparation according to the invention of variant 1. An improvement in the adhesive values could not be achieved.

In addition to unmodified Tylose MHF 15000 P4, mixture FK 4 also contained reference 1 in a concentration of 1.2 wt. %. The pull-off test values showed no improvement here compared with mixture FK 1: a high addition amount of reference 1 had a rather negative effect on the adhesive values after hot and water storage.

In addition to unmodified Tylose MHF 15000 P4, mixture FK 5 also contained reference 1 in a lower concentration of 0.305 wt. %, the active fatty alcohol content corresponding to the fatty alcohol concentration in the preparation of variant 1. The adhesive values were higher with the lower concentration of reference 1 and, compared with FK 1, even showed a slight improvement in the adhesive values after standard and water storage.

Mixtures FK 6 and FK 7 also contained reference 3 and 4, respectively, again in the concentration as contained in 0.2 wt. % in the preparation of variant 1. The adhesive values are comparable with FK 5.

In addition to unmodified Tylose MHF 15000 P4, mixture FK 8 also contained reference 2, the active fatty alcohol content corresponding to the fatty alcohol concentration of the preparation of variant 1. It was possible to improve the adhesive values enormously. The same applies to mixtures FK 9 and FK 10, which also contained reference 3 and 4, respectively. An improvement as a result of the references could not be observed; the adhesive values were almost the same.

In addition to unmodified Tylose MHF 15000 P4, mixtures FK 11 and FK 12 also contained the preparation according to the invention of variant 1 in a concentration of 0.2 wt. %. Mixtures FK 14 and FK 15 contained 0.165 wt. % and were added to the Tylose MHF 15000 P4 as a modifier. The pull-off test values of the standard and water storage showed similarly good values, but the adhesive values of the water storage of both mixtures FK 14 and FK 15 were significantly higher at 2.52 and 2.07 N/mm², respectively.

Mixture FK 16 contained the preparation of variant 2 and displayed somewhat higher pull-off test values, especially after standard storage, than mixtures FK 11 and FK 12, which contained the preparation of variant 1 according to the invention.

Mixture FK 17 contained reference 1 in addition to unmodified Tylose MHF 15000 P4. The concentration of the active fatty alcohol is adapted to the fatty alcohol concentration as contained in the amount of 0.5 wt. % of the preparation according to the invention of variant 2. The adhesive values of the various storage types were comparable with the previous mixtures containing reference 1.

In addition to the unmodified cellulose ether, mixture FK 18 also contained reference 2, the concentration of the fatty alcohol again being adapted to that of the preparation according to the invention. The adhesive values after standard and water storage were somewhat lower than those of mixture FK 16 with the preparation according to the invention of variant 2.

### Conclusion:

In general, by using the preparation according to the invention of variant 1 in conjunction with unmodified cellulose ether, extremely long wetting, a very long open time and very high adhesive values can be achieved in all storage types. The same applies to the use of the preparation according to the invention of variant 2. In comparison, the use of fatty alcohol on a siliceous carrier (reference 1) to extend the open time is not expedient. The aqueous fatty alcohol emulsion (reference 2) works better, but has to be added to the mixing water and not to the dry mortar mixture in order to develop the good properties, which is not user-friendly.

TABLE 13
Results of the open time (OT) according to EN 1346 [N/mm²] of tile adhesives with Tylose MHF 10015 P4 with
and without the preparation according to the invention of variant 1 and the references thereof with 30 wt. % water

| | | References | | | | | | | | |
|---|---|---|---|---|---|---|---|---|---|---|
| | | 1 | 1 | 1 + 3 | 1 + 4 | 2 | 2 + 3 | 2 + 4 | | |
| Test mixture | FK 19 | FK 20 | FK 21 | FK 22 | FK 23 | FK 24 | FK 25 | FK 26 | FK 27 | FK 28 |
| OT after 10 minutes | 1.35 | 0.97 | 1.37 | 1.21 | 1.42 | 1.70 | 1.80 | 1.57 | 1.87 | 1.57 |
| OT after 20 minutes | 1.49 | 0.64 | 1.35 | 1.15 | 1.49 | 1.69 | 1.70 | 1.60 | 1.88 | 1.72 |
| OT after 30 minutes | 1.38 | 0.43 | 1.44 | 1.18 | 1.36 | 1.66 | 1.62 | 1.73 | 1.78 | 1.76 |
| OT after 40 minutes | 1.41 | | 1.19 | 1.22 | 1.36 | 1.54 | 1.48 | 1.57 | 1.68 | 1.52 |
| OT after 50 minutes | 1.33 | | 1.22 | 1.33 | 1.33 | 1.35 | 1.42 | 1.41 | 1.71 | 1.58 |
| OT after 60 minutes | 1.14 | | 1.11 | 1.24 | 1.08 | 1.28 | 1.17 | 1.23 | 1.63 | 1.42 |

TABLE 14
Results of the open time (OT) according to EN 1346 [N/mm²] of tile adhesives with Tylose MHF 10015 P4 with
and without the preparation according to the invention of variant 1 and the references thereof with 24 wt. % water

| | | References | | | | | | | | |
|---|---|---|---|---|---|---|---|---|---|---|
| | | 1 | 1 | 1 + 3 | 1 + 4 | 2 | 2 + 3 | 2 + 4 | | |
| Test mixture | FK 29 | FK 30 | FK 31 | FK 32 | FK 33 | FK 34 | FK 35 | FK 36 | FK 37 | FK 38 |
| OT after 10 minutes | 1.84 | 0.87 | 1.80 | 1.91 | 2.10 | 2.13 | 2.15 | 2.14 | 2.25 | 2.17 |
| OT after 20 minutes | 1.53 | 0.56 | 1.47 | 1.52 | 1.62 | 1.97 | 2.07 | 2.08 | 2.21 | 2.19 |
| OT after 30 minutes | 1.08 | 0.34 | 1.02 | 0.83 | 1.08 | 1.79 | 1.77 | 1.74 | 2.00 | 1.94 |
| OT after 40 minutes | 0.34 | | 0.28 | 0.25 | 0.45 | 0.97 | 1.05 | 1.00 | 1.39 | 1.41 |
| OT after 50 minutes | | | 0.19 | 0.15 | 0.15 | 0.91 | 0.91 | 0.85 | 1.22 | 1.05 |
| OT after 60 minutes | | | | | | 0.53 | 0.46 | 0.53 | 0.89 | 0.76 |

TABLE 15
Results of the storage tests according to DIN EN 1348 [N/mm²] of tile
adhesives with Tylose MHF 10015 P4 with and without preparation according
to the invention of variant 1 and the references thereof with 30 wt. % water

| | | References | | | | | | | | |
|---|---|---|---|---|---|---|---|---|---|---|
| | | 1 | 1 | 1 + 3 | 1 + 4 | 2 | 2 + 3 | 2 + 4 | | |
| Test mixture | FK 19 | FK 20 | FK 21 | FK 22 | FK 23 | FK 24 | FK 25 | FK 26 | FK 27 | FK 28 |
| Standard | 1.09 | 0.39 | 1.14 | 1.17 | 1.30 | 1.21 | 1.18 | 1.10 | 1.20 | 1.26 |
| Hot | 1.38 | 0.13 | 1.35 | 0.86 | 1.29 | 1.43 | 1.50 | 1.45 | 1.86 | 1.49 |
| Water | 1.07 | 0.52 | 0.82 | 0.85 | 0.84 | 1.37 | 1.25 | 1.28 | 1.48 | 1.40 |

TABLE 16
Results of the storage tests according to DIN EN 1348 [N/mm²] of tile
adhesives with Tylose MHF 10015 P4 with and without the preparation according
to the invention of variant 1 and the references thereof with 24 wt. % water

| | | References | | | | | | | | |
|---|---|---|---|---|---|---|---|---|---|---|
| | | 1 | 1 | 1 + 3 | 1 + 4 | 2 | 2 + 3 | 2 + 4 | | |
| Test mixture | FK 29 | FK 30 | FK 31 | FK 32 | FK 33 | FK 34 | FK 35 | FK 36 | FK 37 | FK 38 |
| Standard | 1.06 | 0.45 | 0.93 | 0.95 | 1.11 | 1.04 | 1.00 | 1.13 | 1.12 | 1.24 |
| Hot | 1.14 | 0.21 | 1.09 | 0.86 | 0.99 | 1.33 | 1.36 | 1.40 | 1.67 | 1.69 |
| Water | 0.79 | 0.62 | 0.94 | 0.80 | 0.78 | 1.20 | 1.25 | 1.19 | 1.27 | 1.40 |

### Open Time According to DIN EN 1346:

The tests with the modified cellulose ether were carried out with different water factors. 30 wt. % water is the normal water requirement of the cellulose ether used, which also ensures stability. All mixtures were therefore made up with 30 wt. % water. The preparation according to the invention of variant 1 has a slightly liquefying effect on the adhesive, which is why the stability of 50.5 mm could not be achieved with 30 wt. % water. The water requirement had to be reduced to 24 wt. % in order to ensure stability.

Mixture FK 19 and FK 29 contained the modified Tylose MHF 10015 P4 and dispersion powder, which explains the good open times. However, even after 60 minutes, FK 19 still showed adhesive values of 1.14 N/mm², which was caused by the water requirement of 30 wt. % required for this cellulose ether. With a lower water content of 24 wt. %, FK 29 reached only 0.34 N/mm² after 40 minutes.

In addition to the modified Tylose MHF 10015 P4 and dispersion powder, mixtures FK 20 and 30 contained reference 1 in a concentration of 1.2 wt. %. Here, too, a negative influence of the high reference 1 concentration was observed for both water factors. An open time of only 20 minutes was achieved, which is not sufficient for a C2 adhesive.

Mixtures FK 21 and FK 31 contained, in addition to the modified Tylose MHF 10015 P4 and dispersion powder, reference 1 in a lower concentration of 0.305 wt. %, the active fatty alcohol content again corresponding to the fatty alcohol content in 0.2 wt. % of the preparation according to the invention of variant 1. The open times for both water factors were now again comparable with those of the mixtures without reference 1. A positive effect could therefore not be identified.

Mixtures FK 22, FK 23, FK 32 and FK 33 also contained reference 3 or reference 4 or the same amount of Tylose MOBS 6 P4 or MH 50 G4 as contained in the preparation according to the invention of variant 1 in 0.2 wt. %. Mixtures FK 23 and FK 33 were able to achieve slightly better adhesive values for both water factors than mixtures FK 22 and FK 32 compared with mixtures FK 21 and 31. Tylose MH 50 G4 had a slightly positive effect on the open time and could be observed with 30 wt. % and 24 wt. % water.

Mixtures FK 24 and FK 34 contained reference 2 in addition to the modified Tylose MHF 10015 P4 and dispersion powder, the fatty alcohol content here corresponding to the fatty alcohol content in 0.2 wt. % of the preparation according to the invention of variant 1. The adhesive values with 24 wt. % water were above all higher than with 30 wt. % water up to 30 minutes of open time. While the adhesive values after 30 minutes with 30 wt. % water were all still above 1 N/mm², the adhesive values at 24 wt. % water fell below 1 N/mm². After 60 minutes, only 0.53 N/mm² was reached here, while the value was still 1.28 N/mm² with a higher water content. In a direct comparison with mixture FK 19 and FK 29 without fatty alcohol, all adhesive values were higher, with a significant difference at 24 wt. % water.

Mixtures FK 25, FK 26, FK 35 and FK 36 also contained reference 3 or 4, the concentration of which again corresponded to the concentration in 0.2 wt. % of the preparation according to the invention of variant 1. In direct comparison with mixture FK 24 and FK 34, all adhesive values for both water factors were almost identical, with no positive or negative effect of references 3 and 4 being observed.

Mixtures FK 27, FK 28, FK 37 and FK 38 contained the preparation according to the invention of variant 1 in addition to the modified Tylose MHF 10015 P4 and dispersion powder. At both 30 wt. % and 24 wt. % water, mixtures FK 27 and FK 37 achieved somewhat higher adhesive values than mixtures FK 28 and FK 38. In direct comparison with the mixtures containing reference 2, all four mixtures displayed higher adhesive values after 50 and 60 minutes. A significant tendency towards higher adhesive values was observed in particular for mixtures FK 27 and FK 37.

The high adhesive values of over 2 N/mm² of mixture FK 37 with 24 wt. % after 10, 20 and 30 minutes were remarkable. Mixture FK 38 was similarly good, but after 30 minutes was just below 2 N/mm² at 1.94 N/mm².

It was thus possible to achieve a significant improvement in the adhesive values using the preparation according to the invention compared with the mixtures with the fatty alcohol emulsion (reference 2).

### Storage Types According to DIN EN 1348:

Mixtures FK 19 and FK 29 only contained the modified Tylose MHF 10015 P4 and dispersion powder. The adhesive values for FK 19 with 30 wt. % water met the C2 standard, but the adhesive values for FK 29 with 24 wt. % water only met the C2 standard for standard and hot storage.

Mixtures FK 20 and FK 30 also contained reference 1 in a concentration of 1.2 wt. % in addition to the modified Tylose MHF 10015 P4 and dispersion powder. For both water factors, a clearly negative influence of reference 1 on the adhesive values of the storage types could again be observed. The C2 standard was not met for either of the two mixtures.

Mixtures FK 21 and FK 31 contained reference 1 in addition to the modified Tylose MHF 10015 P4 and dispersion powder, the active fatty alcohol content again corresponding to the fatty alcohol content in 0.2 wt. % of the preparation according to the invention of variant 1. The adhesive values were again higher. It was possible to achieve adhesive values similar to those of mixture FK 19, especially with 30 wt. % water. With 24 wt. % water, the adhesive values were generally somewhat lower. The C2 standard for both water factors was not achieved for all storage types.

Mixtures FK 22, FK 23, FK 32 and FK 33 also contained reference 3 or 4, i.e. the same amount of cellulose ether (Tylose MOBS 6 P4 or MH 50 G4) as contained in 0.2 wt. % in the preparation according to the invention of variant 1. An improvement in the adhesive values achieved with mixture FK 21 or FK 31 could not be determined.

Mixtures FK 24 and FK 34 contained reference 2 in addition to the modified Tylose MHF 10015 P4 and dispersion powder, the active fatty alcohol content again corresponding to the alcohol content in 0.2 wt. % of the preparation according to the invention of variant 1. The adhesive values for both water factors are similar with slightly higher adhesive values at 30 wt. % water. However, compared with mixtures FK 19 and FK 29, significantly higher adhesive values could be achieved. The C2 standard was met for both water factors.

Mixtures FK 25, FK 26, FK 35 and FK 36 also contained reference 3 or 4, i.e. the same amount of cellulose ether (Tylose MOBS 6 P4 or MH 50 G4) as contained in 0.2 wt. % in the preparation according to the invention of variant 1. An improvement in the adhesive values achieved with mixture FK 24 or FK 34 could not be determined here either.

Mixtures FK 27, FK 28, FK 37 and FK 38 contained the preparation according to the invention of variant 1 in addition to the modified Tylose MHF 10015 P4 and dispersion powder. High adhesive values could be achieved for both water factors. In comparison with the mixtures without the preparation according to the invention and without references, it was possible to achieve a clear improvement in the adhesive values. For mixtures FK 27 and FK 37, very high adhesive values were observed for both water factors after hot storage. Only mixture FK 38 was comparably good here. Compared with the mixtures containing reference 2, it was possible to achieve predominantly higher adhesive values with the preparation according to the invention of variant 1.

### Conclusion:

By using the preparation according to the invention of variant 1 in combination with modified cellulose ether, it was possible to achieve an extremely long wetting, a very long open time and very high adhesive values for all storage types. In comparison with the use of the aqueous fatty alcohol emulsion (reference 2), better wetting with the resulting longer open times can be achieved with the preparation according to the invention of variant 1. The preparation of variant 1 according to the invention can also have a positive effect on the storage types, in particular hot storage, with significantly higher pull-off test values than without preparation or with reference 1 or 2.

Tests with CEM II/AS and CEM II/BP:

Tests were carried out with composite cements, the tile adhesive mixtures now containing either CEM 42.5 R/AS or CEM 42.5 R/BP instead of the CEM I 52.5 N used.

Here, too, it was possible to observe a positive effect on the wetting, the open time and the pull-off test values of the various storage types as a result of the use of the preparations according to the invention. The wetting and the pull-off test values were not quite as high as with CEM I, but with CEM 1142.5 R/AS they were still able to reach 0.58-0.75 N/mm² up to 60 minutes. The mixtures based on CEM 42.5 R/BP with just the preparation according to the invention of variant 1 were able to achieve pull-off test values of 0.56 and 0.52 N/mm² after 40 minutes. Both the aqueous emulsion and the fatty alcohols attached to a carrier only achieved values of <0.2 N/mm² here.

The adhesive values after the different storage types displayed comparably good values using the preparations according to the invention and the aqueous emulsion, which for the most part were in the C2 range, i.e. >1 N/mm².

### Extending the Open Time and Processing Time of Other Dry Mortars:

Tests to extend the open time and processing time by using the preparations according to the invention of variants 1 and 2 in the reinforcing filler for ETICS, lime-cement plaster and in the skim coat or cement surface filler were also able to achieve good results.

The open time for applying the reinforcing fabric in the reinforcing filler for ETICS was comparable with the wetting time of the tile adhesive. After 60 minutes, the mesh could still be inserted without any problems. The wetting was also tested here using tiles. After 60 minutes, it was still possible to wet 65% or 55% of the back of the tile with the two preparations according to the invention.

The processing time of lime-cement plaster is between 50 and 60 minutes when using a suitable cellulose ether. As a result of the preparations according to the invention, the processing time could be extended to 70 or 90 minutes.

It was also possible to observe a positive effect such as a longer processing time of the preparations according to the invention in the skim coat.

Tests with Polysaccharides:

Further tests were carried out with water-soluble substances and polysaccharides. Tylovis PVA 18 (polyvinyl acetate), polyacrylamide, pectin, carrageenan, guar gum and derivatives thereof, and locust bean gum were included in the tests.

With the exception of polyacrylamide, all substances were produced like the preparation according to the invention of variant 2. Here, the aqueous alcohol emulsion was kneaded in equal parts into the water-soluble substances.

Since polyacrylamide is difficult to process when used in too high a quantity, the production process of the preparation of variant 1 was chosen. The emulsion was diluted 1:1 with water, the polyacrylamide being stirred in after complete homogenisation. After a mixing time of 2 hours, the solution was dried and then ground to form a powder.

The preparations produced in this way were used in 0.2 or 0.5 wt. % in addition to 0.3 or 0.4 wt. % of unmodified Tylose MHF 15000 P4 in the same tile adhesive formulation as described above. Cellulose ether is indispensable in all formulations, since otherwise there is no water retention or good processing in order to achieve acceptable wetting times. It was found that, with the same water content of 23 wt. %, the wetting times were not extended to the same degree as when preparations based on cellulose ether were used.

Guar gum and derivatives thereof, and locust bean gum showed the longest wetting times and after 45 minutes still achieved 65 and 50% wetting of the back of the tile, respectively. After 50 minutes, the wetting decreased to 20%. Carrageenan and pectin achieved a good wetting time of 40 minutes. It was not possible to process the Tylovis PVA 18 because the preparation agglomerated during the drying process.

The preparations based on cellulose ethers and polysaccharides thus display the best effect on extension of the open time or wetting time.

### LITERATURE

Jenni, A.; Holzer, L.; Zurbriggen, R.; Herwegh, M.; Influence of polymers on microstructure and adhesive strength of cementitious tile adhesive mortar, Cement and Concrete Research 35, 2005, 35-50.

1. A preparation, comprising
(i) at least one cellulose ether and/or a polysaccharide or a derivative thereof,
(ii) at least one fatty alcohol or a dimer or trimer thereof,
(iii) optionally at least one hydraulic binder and
(iv) optionally at least one aggregate.

2. The preparation according to claim 1, wherein component (i) and component (ii) are present as solids.

3. The preparation according to claim 1, wherein component (i) and component (ii) are present together in one particle.

4. The preparation according to claim 3, wherein component (i) and component (ii) are distributed as homogeneously as possible in the particle, or component (ii) is accumulated on component (i).

5. The preparation according to claim 3, wherein the average diameter d₅₀ of the particle is in the range of 0.01-1,000 μm, preferably 0.01-500 μm, more preferably 0.01-250 μm.

6. The preparation according to claim 1, wherein component (i) and component (ii) are present as a solid solution.

7. The preparation according to claim 1, wherein the polysaccharides and derivatives thereof are selected from guar gum, guar ether, locust bean gum, carrageenan and pectin.

8. The preparation according to claim 1, wherein the cellulose ether is selected from methyl cellulose (MC), methyl hydroxypropyl cellulose (MHPC), methyl hydroxyethyl cellulose (MHEC), hydroxyethyl cellulose (HEC), ethyl hydroxyethyl cellulose (EHEC), methyl ethyl hydroxyethyl cellulose (MEHEC), carboxymethyl cellulose ether (CMC), carboxymethyl hydroxyethyl cellulose ether (CMHEC), carboxymethyl hydroxypropyl cellulose ether (CMHPC), carboxymethyl methyl cellulose ether (CMMC), carboxymethyl methyl hydroxyethyl cellulose ether (CMMHEC), carboxymethyl methyl hydroxypropyl cellulose ether (CMMHPC), sulfoethyl methyl cellulose ether (SEMC), sulfoethyl methyl hydroxyethyl cellulose ether (SEMHEC), sulfoethyl methyl hydroxypropyl cellulose ether (SEMHPC) and methyl hydroxyethyl hydroxypropyl cellulose ether (MHEHPC), preferably methyl hydroxypropyl cellulose and methyl hydroxyethyl cellulose.

9. The preparation according to claim 8, wherein methyl cellulose has an average degree of substitution DS_{methyl} of 1.4 to 2.2, preferably 1.6 to 2.0; methyl hydroxypropyl cellulose (MHPC) has an average degree of substitution DS_{methyl} of 1.2 to 2.2, preferably 1.3 to 2.0, and preferably a molecular degree of substitution MS_{hydroxypropyl} of 0.1 to 1.0, more preferably 0.15 to 0.7; methyl hydroxyethyl cellulose (MHEC) has an average degree of substitution DS_{methyl} of 1.2 to 2.2, preferably 1.4 to 1.9, and preferably a molecular degree of substitution MS_{hydroxyethyl} of 0.05 to 0.4, particularly preferably 0.1 to 0.35; hydroxyethyl cellulose (HEC) has an average degree of substitution MS_{hydroxyethyl} of 1.2 to 4.0, preferably 1.6 to 3.5; ethyl hydroxyethyl cellulose (EHEC) has an average degree of substitution DS_{ethyl} of 0.5 to 1.5, and preferably a molecular degree of substitution MS_{hydroxyethyl} of 1.5 to 3.5; methyl ethyl hydroxyethyl cellulose (MEHEC) has an average degree of substitution DS_{methyl} of 0.2 to 2.0 and an average degree of substitution DS_{ethyl} of 0.05 to 1.5 and preferably a molecular degree of substitution MS_{hydroxyethyl} of 0.2 to 3.5; carboxymethyl cellulose ether (CMC) has an average degree of substitution DS_{carboxymethyl} of 0.4 to 1.0; carboxymethyl hydroxyethyl cellulose ether (CMHEC) has an average degree of substitution DS_{carboxymethyl} of 0.1 to 1.0 and preferably a molecular degree of substitution MS_{hydroxyethyl} of 0.8 to 3.5; carboxymethyl hydroxypropyl cellulose ether (CMHPC) has an average degree of substitution DS_{carboxymethyl} of 0.1 to 1.0 and preferably a molecular degree of substitution MS_{hydroxypropyl} of 0.8 to 3.3; carboxymethyl methyl cellulose ether (CMMC) has an average degree of substitution DS_{carboxymethyl} of 0.005 to 1.0 and preferably has an average degree of substitution DS_{methyl} of 0.2 to 2.0; carboxymethyl methyl hydroxyethyl cellulose ether (CMMHEC) has an average degree of substitution DS_{carboxymethyl} of 0.005 to 1.0, an average degree of substitution DS_{methyl} of 0.2 to 2.0, and preferably has a molecular degree of substitution MS_{hydroxyethyl} of 0.8 to 3.5; carboxymethyl methyl hydroxypropyl cellulose ether (CMMHPC) has an average degree of substitution DS_{carboxymethyl} of 0.005 to 1.0, an average degree of substitution DS_{methyl} of 0.2 to 2.0; and preferably has a molecular degree of substitution MS_{hydroxypropyl} of 0.8 to 3.3;
sulfoethyl methyl cellulose ether (SEMC) has an average degree of substitution DS_{sulfoethyl} of 0.005 to 0.01 and preferably an average degree of substitution DS_{methyl} of 0.2 to 2.0;
sulfoethyl methyl hydroxyethyl cellulose ether (SEMHEC) has an average degree of substitution DS_{sulfoethyl} of 0.005 to 0.01, an average degree of substitution DS_{methyl} of 0.2 to 2.0, and preferably a molecular degree of substitution MS_{hydroxyethyl} of 0.1 to 0.3;
sulfoethyl methyl hydroxypropyl cellulose ether (SEMHPC) has an average degree of substitution DS_{sulfoethyl} from 0.005 to 0.01, an average degree of substitution DS_{methyl} from 0.2 to 2.0, and preferably a molecular degree of substitution MS_{hydroxypropyl} from 0.1 to 0.3 and methyl hydroxyethyl hydroxypropyl cellulose ether (MHEHPC) has an average degree of substitution DS_{methyl} from 1.2 to 2.0, preferably 1.4 to 1.8, and preferably a molecular degree of substitution MS_{hydroxyethyl} from 0.1 to 1.0, particularly preferably 0.3 to 0.5, and preferably a molecular degree of substitution MS_{hydroxypropyl} from 0.1 to 1.0, more preferably 0.15 to 0.7.

10. The preparation according to claim 1, wherein the cellulose ether has an average degree of polymerisation of 10 to 5,000.

11. The preparation according to claim 1, wherein the cellulose ether and/or the polysaccharide has a water solubility of at least 2 g/l water at 20° C.

12. The preparation according to claim 1, wherein the cellulose ether has a viscosity of 1 to 500,000 mPa s, preferably 3 to 300,000 mPa s, more preferably 6 to 60,000 mPa s (Höppler; 2% solution; 20° C.; 20° dH).

13. The preparation according to claim 1, wherein the fatty alcohol or the dimer or trimer thereof is of synthetic or natural origin.

14. The preparation according to claim 1, wherein the fatty alcohol is a C₆₋₃₀ alkanol, C₆₋₃₀ alkenol, C₆₋₃₀ alkanedienol, C₆₋₃₀ alkanetrienol or oxo alcohol.

15. The preparation according to claim 1, wherein component (i) and component (ii) together have a residual moisture content of 0-20 wt. %, preferably 0-10 wt. %, based on the total mass of components (i)+(ii).

16. The preparation according to claim 1, wherein the weight ratio of component (i) to component (ii) is in the range of 1:15 to 15:1, preferably 1:4 to 4:1.

17. The preparation according to any of the preceding claim 1, wherein the proportion of components (i) and (ii) is 0.1-100 wt. %, preferably 0.1-1.0 wt. %, more preferably 0.2-0.5 wt. %, based on the total mass of the preparation.

18. The preparation according to claim 1, wherein the hydraulic binder is selected from cement, quicklime, pozzolan, trass and gypsum, preferably cement.

19. The preparation according to claim 1, wherein the aggregate is selected from sand, gravel and synthetic fillers.

20. The preparation according to claim 1, further comprising
(v) at least one additional cellulose ether or a derivative thereof.

21. The preparation according to claim 1, wherein the preparation is a dry mortar, tile adhesive, spackling paste, plaster system or dry mortar for thermal insulation composite systems.

22. A method for producing a preparation according to claim 1, comprising the steps of
(a) mixing at least one cellulose ether and/or a polysaccharide or a derivative thereof, at least one fatty alcohol or dimer or trimer thereof and at least one solvent,
(b) treating the mixture obtained after step (a) under shear stress, optionally at elevated temperatures,
(c) drying and optionally comminuting the mixture obtained after step (b) and
(d) optionally mixing the mixture obtained after step (c) with at least one hydraulic binder and optionally with at least one aggregate.

23. The method according to claim 22, wherein the solvent is water.

24. The method according to claim 22, wherein at least one fatty alcohol and the solvent are present in the form of an emulsion.

25. The method according to claim 24, wherein the emulsion contains 5 to 40 wt. % of fatty alcohol, based on the total mass of the emulsion.

26. The method according to claim 22, wherein step (b) takes place with stirring or kneading.

27. The method according to claim 22, wherein the mixture obtained after step (c) has a residual moisture content of 0-20 wt. %, preferably 0-10 wt. %, based on the total mass of the mixture.

28. Use of the preparation according to claim 1 as a construction material or as an additive for construction materials.

29. The use according to claim 28, wherein the construction material is selected from mortar systems, in particular for thermal insulation composite systems, plaster systems, spackling pastes and tile adhesives.

30. The use according to claim 28 for extending open time, for improving wetting, for extending processing time and for improving pull-off test values.
